(19) United States
(12) Patent Application Publication
(10) Pub. No.: US 2013/0081231 A1
(43) Pub. Date: Apr. 4, 2013

(54) TELESCOPIC HAND TOOL

(71) Applicant: Chin-Tan Huang, Taichung City (TW)

(72) Inventor: Chin-Tan Huang, Taichung City (TW)

(21) Appl. No.: 13/463,862

(22) Filed: May 4, 2012

(30) Foreign Application Priority Data
Oct. 3, 2011 (TW) 100218526

(51) Int. Cl. B25G 1/04

(52) U.S. Cl. 16/429

(57) ABSTRACT

A telescopic hand tool includes a main shank connected to a tool head at one end and inserted into an outer sleeve for gripping by a user. The outer sleeve has an inner surface including a first arcuate region extending along a circumferential line, and a second arcuate region displaced from the first arcuate region, disposed radially outward of the circumferential line, and having low and increased friction areas. A block attachment is disposed on the other end of the main shank, and has an engaging segment engageable interferingly with the increased friction area to prevent rotation of the outer sleeve relative to the main shank.

### CROSS-REFERENCE TO RELATED APPLICATION

This application claims priority of Taiwanese Utility Model Application No. 100218526, filed on Oct. 3, 2011, the disclosure of which is herein incorporated by reference.

### BACKGROUND OF THE INVENTION

1. Field of the Invention

This invention relates to a hand tool, more particularly to a telescopic hand tool.

2. Description of the Related Art

A conventional torque hand tool, such as a ratchet wrench, generally includes a driving head and a handle connected to the driving head. The handle includes a main shank fixed to the driving head at one end, and an outer sleeve movably sleeved on the main shank to be extendible or retractable relative to the driving head so as to facilitate stowage of the hand tool.

In Taiwanese Utility Model Publication No. M319126, a hand tool with such a telescopic structure has been disclosed, which, as shown in FIG. 1, includes a main shank 1 connected to a driving head, a spring-loaded friction retainer 3 disposed in the main shank 1 adjacent to a rear end thereof, an annular stem 4 with a toothed rim 41 disposed eccentrically on the rear end of the main shank 1, and an outer sleeve 2 movably sleeved on the main shank 1. By means of the friction retainer 3 that engages an inner peripheral surface of the outer sleeve 2, once a force applied to the outer sleeve 2 to pull the outer sleeve 2 away from the driving head for placing the hand tool in an extended state is removed, the outer sleeve 2 can be retained on the main shank 1. In addition, by virtue of a camming action between the toothed rim 41 and the outer sleeve 2 generated as a result of turning of the outer sleeve 2 about its axis, the friction retainer 3 engages the inner peripheral surface of the outer sleeve 2 with an increased friction force, thereby preventing slipping rotation of the outer sleeve 2 relative to the main shank 1. However, as the toothed rim 41 is brought to drag on the inner peripheral surface of the outer sleeve 2 along a circumferential line, complete immobility of the outer sleeve 2 relative to the main shank 1 during application of a torque cannot be ensured, particularly in view of the wear of the material forming the outer sleeve 2. Thus, there is a need for improvement.

### SUMMARY OF THE INVENTION

An object of the present invention is to provide a telescopic hand tool which can be kept steadily in its extended state during operation of the hand tool.

According to this invention, a telescopic hand tool includes an outer sleeve and a main shank. The outer sleeve is elongated along a turning axis to terminate at first and second ends, and having an inner peripheral surface which defines an axial bore. The inner peripheral surface has at least one first arcuate surface region which angularly extends about the turning axis along a circumferential line, and at least one second arcuate surface region which is angularly displaced from the first arcuate surface region in a turning direction about the turning axis, and which is disposed radially and outwardly of the circumferential line. The second arcuate surface region has a low friction area and an increased friction area which is opposite to the low friction area in the turning direction. The main shank has a distal end for connection to a tool head, a proximate end opposite to the distal end along the turning axis, and an outer surrounding surface which extends between the distal and proximate ends. The outer surrounding surface is configured to be inserted into the axial bore so as to be telescopically movable and rotatable relative to the inner peripheral surface along and about the turning axis. A block attachment is disposed on the proximate end and has a rim surface radially confronting the second arcuate surface region. The rim surface is angularly displaceable relative to the second arcuate surface region from a loosened position, where the rim surface is in slidable contact with the low friction area, to a retained position, where the rim surface is in retained engagement with the increased friction area with an increased frictional force so as to guard against rotation of the outer sleeve relative to the main shank.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic fragmentary sectional view of a conventional telescopic hand tool;

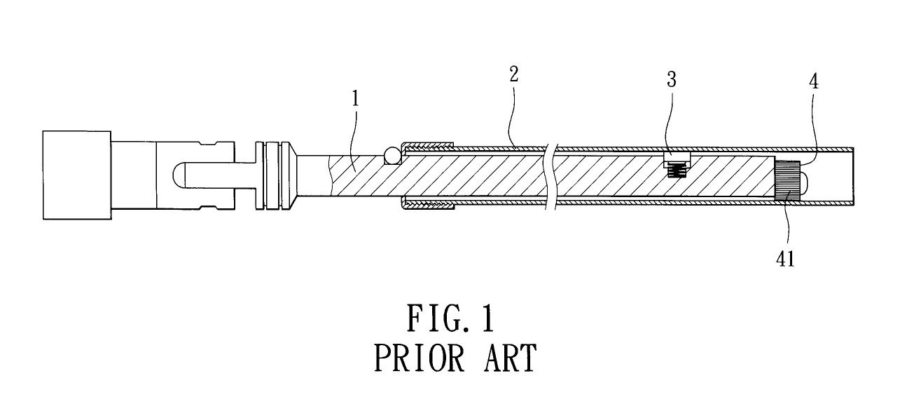

FIG. 2 is a fragmentary sectional view of a first preferred embodiment of a telescopic hand tool according to the present invention;

FIG. 3 is a fragmentary exploded perspective view of the first preferred embodiment;

FIG. 4 is a cross-sectional view taken along line IV-IV of FIG. 2;

FIG. 5 is a fragmentary exploded perspective view of a second preferred embodiment of a telescopic hand tool according to the present invention;

FIG. 6 is a cross-sectional view of the second preferred embodiment;

FIG. 7 is a fragmentary exploded perspective view of a third preferred embodiment of a telescopic hand tool according to the present invention;

FIG. 8 is a cross-sectional view of the third preferred embodiment;

FIG. 9 is a fragmentary exploded perspective view of a fourth preferred embodiment of a telescopic hand tool according to the present invention; and

FIG. 10 is a cross-sectional view of the fourth preferred embodiment.

### DETAILED DESCRIPTION OF THE PREFERRED EMBODIMENTS

Before the present invention is described in greater detail, it should be noted that same reference numerals have been used to denote like elements throughout the specification.

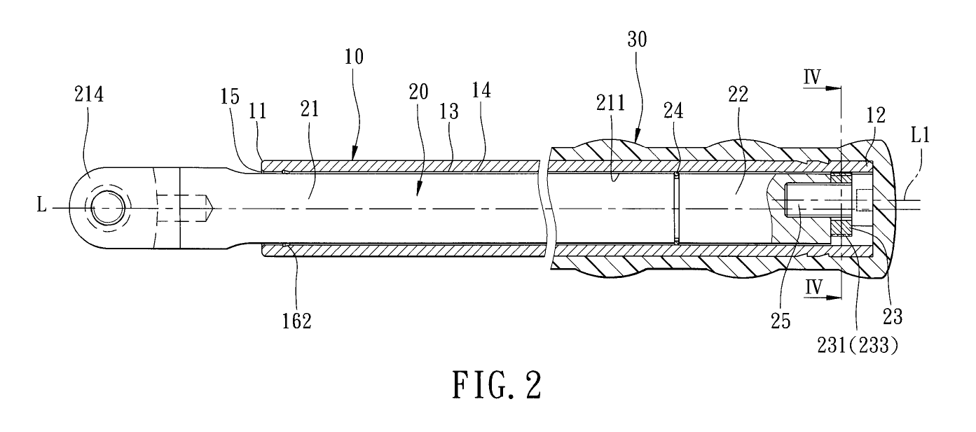

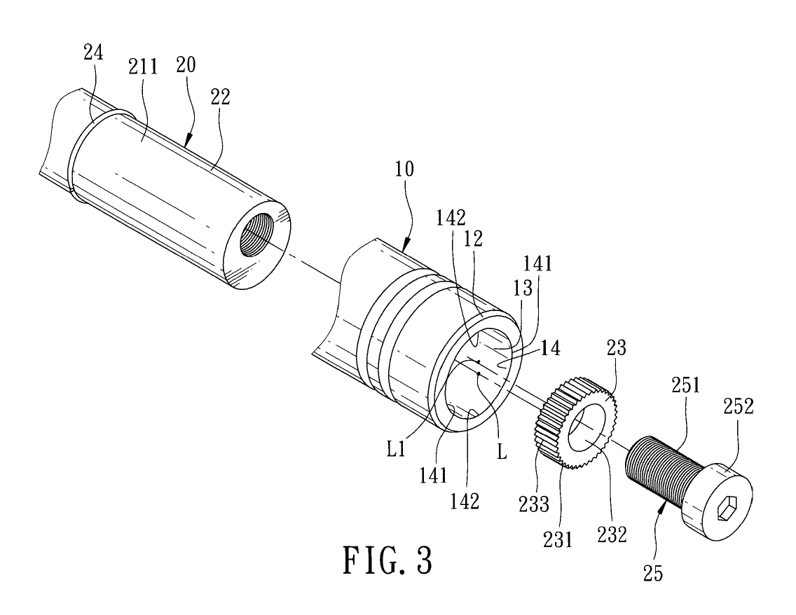

Referring to FIGS. 2 to 4, the first preferred embodiment of a telescopic hand tool according to the present invention is shown to comprise an outer sleeve 10, a main shank 20, a block attachment 23, and a handgrip 30.

The outer sleeve 10 is elongated along a turning axis (L) to terminate at first and second ends 11, 12, and has an inner peripheral surface 14 which defines an axial bore 13. The inner peripheral surface 14 has two first arcuate surface regions 141 which are diametrically opposite to each other relative to the turning axis (L). Each of the first arcuate surface regions 141 angularly extends about the turning axis (L) along a circumferential line (CL). The inner peripheral surface 14 further has two second arcuate surface regions 142 which are diametrically opposite to each other relative to the turning axis (L). Each of the second arcuate surface regions 142 is angularly displaced from the corresponding first arcuate surface region 141 in a turning direction about the turning axis (L), and is disposed radially and outwardly of the circumferential line (CL). Each of the second arcuate surface regions 142 is divided into a low friction area 1421 and an increased friction area 1422 which is forward of the low friction area 1421 in the turning direction.

The main shank 20 has a distal end 21 for connection to a tool head 214, a proximate end 22 opposite to the distal end 21 along the turning axis (L), and an outer surrounding surface 211 extending between the distal and proximate ends 21, 22. The outer surrounding surface 211 is configured to be inserted into the axial bore 13 so as to be telescopically movable and rotatable relative to the inner peripheral surface 14 along and about the turning axis (L).

The block attachment 23 is disposed on the proximate end 22 and has a rim surface 231 radially confronting the second arcuate surface region 142. The rim surface 231 is angularly displaceable relative to the second arcuate surface region 142 from a loosened position, where the rim surface 231 is in slidable contact with the low friction area 1421, to a retained position, where the rim surface 231 is in retained engagement with the increased friction area 1422 with an increased frictional force so as to guard against rotation of the outer sleeve 10 relative to the main shank 20.

In the first preferred embodiment, the block attachment 23 is of a wheel shape and has a dimension smaller than that of the proximate end 22. The block attachment 23 is secured to the proximate end 22 by a bolt member 25 which threadedly engages the proximate end 22 along an offset axis (L1) that is offset from the turning axis (L). After assembly, the radial distance between the offset axis (L1) and the second arcuate surface region 142 is shorter than that between the turning axis (L) and the second arcuate surface region 142 such that an engaging segment 2311 of the rim surface 231 extends radially and outwardly of the outer surrounding surface 211 of the main shank 20. Due to such a configuration of the engaging segment 2311, an interfering engagement, which can provide a much greater frictional force, between the block attachment 23 and a selected one of the second arcuate surface regions 142 can be achieved. Therefore, when the outer sleeve 10 is moved axially along the turning axis (L) to an extended state for applying a desired higher torque, the outer sleeve 10 can be kept in the extended state steadily and assuredly during the torque application without fear that the firm frictional engagement between the outer sleeve 10 and the main shank 20 might fail.

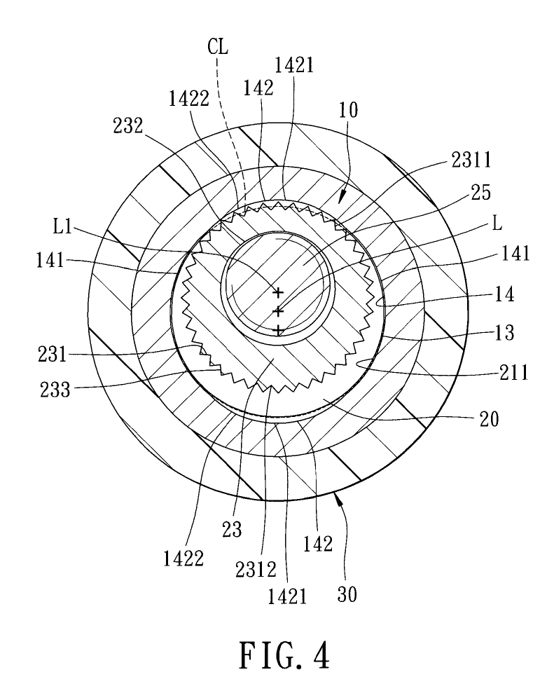

In the first preferred embodiment, the bolt member 25 has a stem 251 that extends along the offset axis (L1), and a bolt head 252 that is configured to be brought by a screw-in action to abut the block attachment 23 against the proximate end 22. The block attachment 23 has a through hole 232 extending along the offset axis (L1) and dimensioned to permit the bolt stem 251 to be fitted therein. Referring to FIG. 4, a non-engaging segment 2312 of the rim surface 231 is disposed diametrically opposite to the engaging segment 2311 in terms of the offset axis (L1), and the engaging segment 2311 is disposed closer to the offset axis (L1) than the non-engaging segment 2312. As clearly shown in FIG. 4, after assembly it is the engaging segment 2311 of the rim surface 231 that is brought into slidable contact with the low friction area 1421 in the loosened position and into retained engagement with the increased friction area 1422 in the retained position.

In accordance with the first preferred embodiment, the block attachment 23 may further include a toothed member 233 disposed on the rim surface 231.

Referring further to FIG. 2, the main shank 20 may be provided with a retaining ring 24 disposed in and extending radially and outwardly of the outer surrounding surface 211 adjacent to the second end 12 such that the main shank 20 is in resilient contact with the inner peripheral surface 14 while the outer surrounding surface 211 is moved telescopically. The inner peripheral surface 14 may further have a shoulder region 162 which is disposed adjacent to the first end 11 and which is configured to extend radially and inwardly of the inner peripheral surface 14 to serve as a stop for the retaining ring 24 so as to prevent excessive axial movement of the outer sleeve 10. In addition, the inner peripheral surface 14 may have a flared region 15 disposed at the first end 11 for facilitating insertion of the proximate end 22 into the axial bore 13 therefrom.

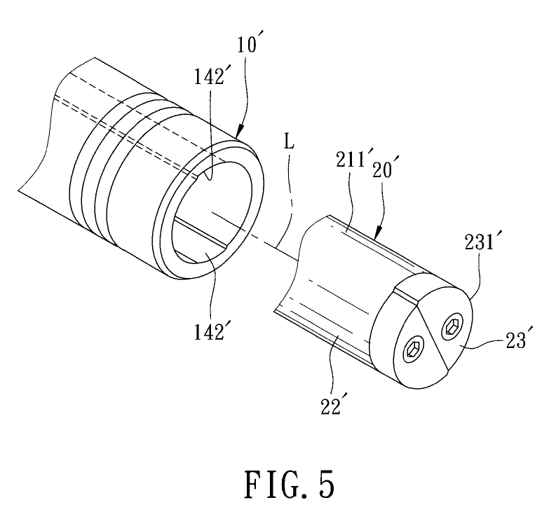

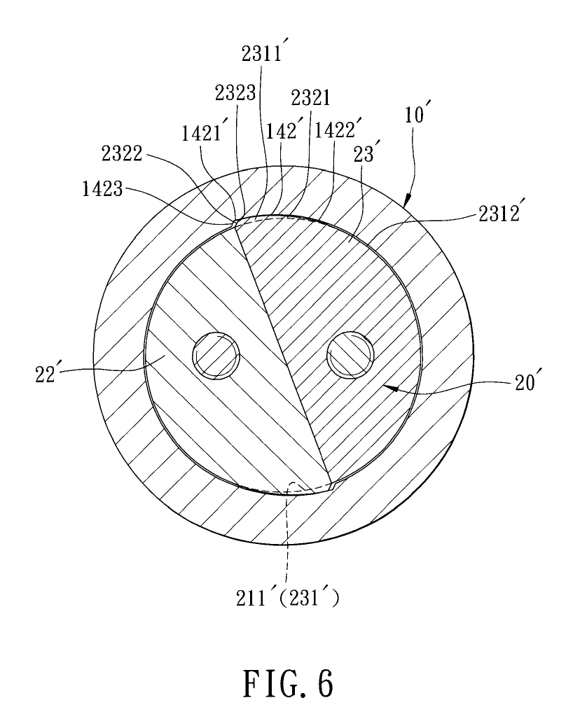

FIGS. 5 and 6 illustrate a second preferred embodiment of the present invention, in which an alternative form of the block attachment 23 is exemplified. In the second preferred embodiment, the second arcuate surface region 142′ of the outer sleeve 10′ is configured to extend gradually away from the turning axis (L) from the increased friction area 1422′ to the low friction area 1421′, which terminates at a barrier wall surface 1423.

In the second preferred embodiment, the block attachment 23′ is configured to be of generally the same dimension as the proximate end 22′ in cross-section with a slight modification in contour. In this connection, the rim surface 231′ is configured to be generally flush with the outer surrounding surface 211′ of the main shank 20′. Specifically, the rim surface 231′ is configured to have a non-engaging segment 2312′ and an engaging segment 2311′ which is disposed forward of the non-engaging segment 2312′. The engaging segment 2311′ is configured to have a trailing region 2321 and a leading region 2322 which is configured to slope up from the trailing region 2321 to terminate at a front abutment surface 2323 that extends radially so as to be engageable with the barrier wall surface 1423 when the rim surface 231′ is turned to the loosened position.

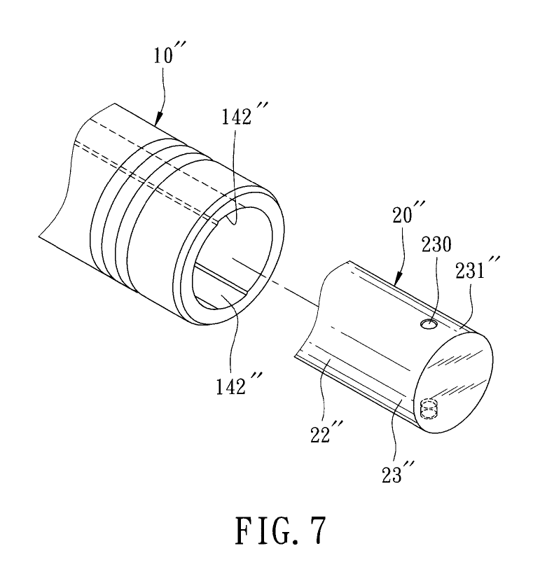

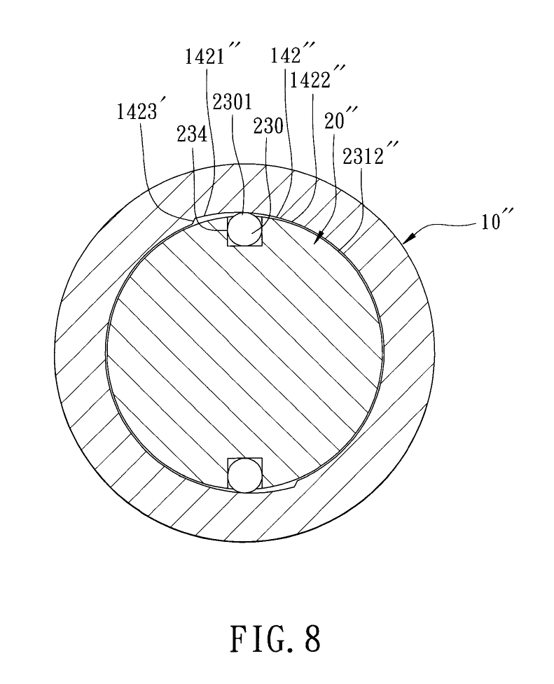

With reference to FIGS. 7 to 8, in the third preferred embodiment of the present invention, the block attachment 23″ is integrally formed with the proximate end 22″ of the main shank 20″, and is made to be of the same dimension as the proximate end 22″ in cross section. In this embodiment, the engaging segment is in the form of a rollable ball 230 which is received in a tubular cavity 234 defined in the block attachment 23″, and which has an outermost area 2301 that extends radially and outwardly of the outer surrounding surface to be in slidable contact with the low friction area in the loosened position and into retained engagement with the increased friction area in the retained position. The rollable ball 230 is engageable with the barrier wall surface 1423′ when the rim surface 231″ is displaced to the loosened position.

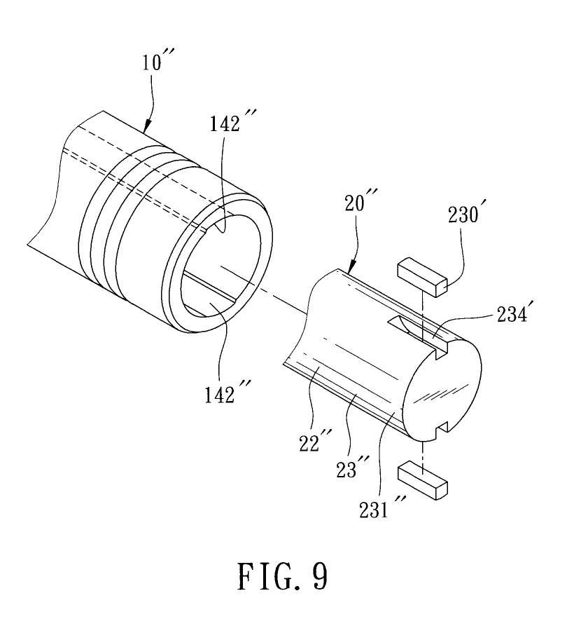

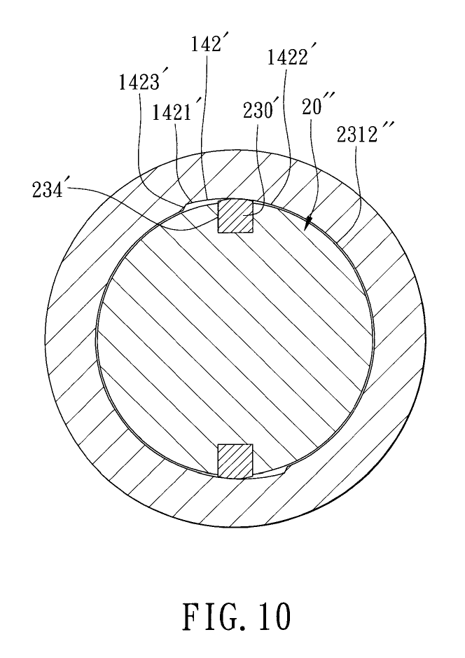

FIGS. 9 and 10 show the fourth preferred embodiment of the present invention, which is similar to the third preferred embodiment. In this embodiment, the engaging segment is in the form of an axially extending engaging body 230′ which is received in an axially extending recess 234′ defined in the block attachment 23″. When the rim surface 231″ is displaced to the loosened position, the axially extending engaging body 230′ is engageable with the barrier wall surface 1423′.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A telescopic hand tool comprising:
an outer sleeve elongated along a turning axis to terminate at first and second ends, and having an inner peripheral surface which defines an axial bore, said inner peripheral surface having at least one first arcuate surface region which angularly extends about the turning axis along a circumferential line, and at least one second arcuate surface region which is angularly displaced from said first arcuate surface region in a turning direction about the turning axis, and which is disposed radially and outwardly of said circumferential line, said second arcuate surface region having a low friction area and an increased friction area which is opposite to said low friction area in the turning direction;
a main shank having a distal end for connection to a tool head, a proximate end opposite to said distal end along the turning axis, and an outer surrounding surface which extends between said distal and proximate ends, and which is configured to be inserted into said axial bore such that said outer surrounding surface is telescopically movable and rotatable relative to said inner peripheral surface along and about the turning axis; and
a block attachment disposed on said proximate end, and having a rim surface which radially confronts said second arcuate surface region and which is angularly displaceable relative to said second arcuate surface region from a loosened position, where said rim surface is in slidable contact with said low friction area, to a retained position, where said rim surface is in retained engagement with said increased friction area with an increased frictional force so as to guard against further rotation of said outer sleeve relative to said main shank.

2. The telescopic hand tool as claimed in claim 1, wherein said main shank further has a retaining ring disposed in and extending radially and outwardly of said outer surrounding surface adjacent to said second end such that said main shank is in resilient contact with said inner peripheral surface while said outer surrounding surface is moved telescopically.

3. The telescopic hand tool as claimed in claim 2, wherein said inner peripheral surface further has a shoulder region which is disposed adjacent to said first end, and which is configured to extend radially and inwardly so as to serve as a stop for said retaining ring thereby preventing excessive axial movement of said outer sleeve.

4. The telescopic hand tool as claimed in claim 3, wherein said inner peripheral surface further has a flared region disposed at said first end for facilitating insertion of said proximate end into said axial bore therefrom.

5. The telescopic hand tool as claimed in claim 1, further comprising:
a bolt member configured to secure said block attachment to said proximate end, and having a stem that extends from said block attachment along a offset axis that is offset from the turning axis, and a bolt head that is configured to abut said block attachment against said proximate end;
said block attachment having a through hole that extends along the offset axis, and that has a dimension larger than that of said stem, said rim surface having engaging and non-engaging segments which are disposed diametrically opposite to each other in terms of said offset axis, said engaging segment being closer to said offset axis than said non-engaging segment, said engaging segment being configured to be brought into slidable contact with said low friction area in the loosened position and into retained engagement with said increased friction area in the retained position.

6. The telescopic hand tool as claimed in claim 5, wherein said block attachment further has a toothed member disposed on said rim surface.

7. The telescopic hand tool as claimed in claim 1, wherein said second arcuate surface region is configured to extend gradually away from the turning axis from said increased friction area to said low friction area so as to terminate at a barrier wall surface.

8. The telescopic hand tool as claimed in claim 7, wherein said block attachment is secured on said proximate end, and said rim surface is configured to be flush generally with said outer surrounding surface, and has a non-engaging segment and an engaging segment which is disposed forward of said non-engaging segment, and which is brought into slidable contact with said low friction area in the loosened position and into retained engagement with the said increased friction area in the retained position, said engaging segment being configured to have a trailing region, and a leading region which is configured to slope up from said trailing region so as to terminate at a front abutment surface that extends radially so as to be engageable with said barrier wall surface in the loosened position.

9. The telescopic hand tool as claimed in claim 7, wherein said block attachment is integrally formed with said proximate end, said rim surface having a non-engaging segment and an engaging segment which is disposed forward of said non-engaging segment, said engaging segment being in form of a rollable ball which is received in a tubular cavity defined in said block attachment, and which has an outermost area extending radially and outwardly of said outer surrounding surface so as to be brought into slidable contact with said low friction area in the loosened position and into retained engagement with said increased friction area in the retained position, said rollable ball being engageable with said barrier wall surface in the loosened position.

10. The telescopic hand tool as claimed in claim 7, wherein said block attachment is integrally formed with said proximate end, said rim surface having a non-engaging segment and an engaging segment, said engaging segment being in form of an axially extending engaging body which is received in an axially extending recess defined in said block attachment, said engaging body being brought into slidable contact with said low friction area in the loosened position and into retained engagement with said increased friction area in the retained position, and being engageable with said barrier wall surface in the loosened position.
